(19) United States
(12) Patent Application Publication
(10) Pub. No.: US 2012/0096639 A1
(43) Pub. Date: Apr. 26, 2012

(54) FAUCET MOUNTED EYEWASH UNIT

(75) Inventors: Stephen Stanley, Sun Valley, NV (US); Ian T. Roberts, Sparks, NV (US); Zoltan Goncze, Reno, NV (US)

(73) Assignee: HAWS CORPORATION, Sparks, NV (US)

(21) Appl. No.: 13/276,236

(22) Filed: Oct. 18, 2011

Related U.S. Application Data
(60) Provisional application No. 61/405,536, filed on Oct. 21, 2010.

(51) Int. Cl. A61H 33/00

(52) U.S. Cl. 4/620

(57) ABSTRACT

A faucet mounted eyewash unit for installation onto the discharge end of a standard faucet spout. The eyewash unit in a normal faucet mode position permits uninterrupted water flow through the faucet spout. In an eyewash mode, a portion of the eyewash unit is rotated quickly and easily to orient a pair of eyewash discharge ports in upwardly open positions, and to couple these eyewash discharge ports to the water flow for upward trajection of a pair of eyewash flushing streams. The eyewash unit further includes a thermostat for preventing hot water flow above a selected temperature level to the eyewash discharge ports.

### BACKGROUND OF THE INVENTION

This invention relates generally to a faucet mounted eyewash unit of a type adapted for installation onto the discharge end of a standard faucet spout. In use, the eyewash unit is movable quickly and easily, and in a single motion, between a normal faucet mode with water discharged in a normal manner from the faucet spout, and an eyewash mode wherein a pair of eyewash flushing streams are directed upwardly for flushing contaminants from a person's eyes.

Faucet mounted eyewash units are generally known in the art. In general, such units comprise a device adapted for mounting onto the downstream or discharge end of a faucet spout mounted generally over a sink or drain. The unit is designed for relatively quick and easy actuation to produce a pair of relatively gentle upflow streams used to flush or irrigate contaminants and the like from a person's eyes. See, e.g., U.S. Pat. Nos. 5,170,518; 4,688,276; 4,675,924; 4,627,845; 3,925,829; and D250,594, each of which is incorporated by reference herein. In general, however, such prior units do not readily permit normal dispensing from the faucet spout when the eyewash streams are not required.

The present invention is quickly and easily interchangeable between a normal faucet mode for normal dispensing of water generally in a downward direction through the faucet spout, and an eyewash mode wherein the pair of upwardly directed eyewash flush flow streams are provided.

### SUMMARY OF THE INVENTION

In accordance with the invention, a faucet mounted eyewash unit is adapted for installation onto the discharge end of a standard faucet spout. The eyewash unit comprises a first portion fixed to the faucet spout and permitting substantially uninterrupted water flow therethrough in a normal faucet mode. A second portion of the eyewash unit is rotatably carried by the first portion and includes a pair of eyewash discharge ports normally oriented downwardly in the faucet mode. This second portion is rotatable quickly and easily to re-orient the eyewash discharge ports in an upwardly open position in an eyewash mode, and to couple these eyewash discharge ports to the water flow for upward trajection of a pair of eyewash flushing streams.

According to one preferred form of the invention, the eyewash unit includes a lock assembly adapted for secure thread-on installation onto the discharge end of a standard faucet spout, of a type installed over a sink and/or associated drain, and designed with cold and hot water valves or a combination thereof operable to select the temperature of water flowing through the faucet spout. In addition, a conventional aerator is removably carried by the eyewash unit is a position in-line with faucet spout water flow, for discharging the selected temperature water at a selected flow rate from the faucet spout.

In the normal faucet mode, the eyewash discharge ports are oriented downwardly, for self-draining of any water contained therein. Water is dispensed generally in a downward direction and in a normal manner via the faucet spout and associated aerator. However, in an eyewash emergency, the second portion of the eyewash unit is rotated quickly and easily to re-orient the eyewash discharge ports in an upwardly open position, with an internal rotary valve sleeve coupling these eyewash discharge ports to the faucet water flow in a single motion for upward discharge of a pair of eyewash flushing streams. In the preferred form, these eyewash flushing streams are discharged upwardly and diverge from each other substantially in opposite directions for inside-out flush flow of a person's eyes. A flow restrictor in the unit limits the eyewash flushing streams to a predetermined flow rate, thereby permitting continued downward discharge of excess water flow through the faucet spout.

The eyewash unit further includes a thermostat for preventing hot water flow above a selected temperature level to the eyewash discharge ports. In a preferred form, the thermostat comprises a cartridge such as that available from Kerox Ltd. of Budapest, Hungary, under, e.g., model no. WM-5. This thermostat cartridge is designed to expand in response to water temperature for substantially blocking water flow through the rotary valve sleeve to the eyewash ports, when the water temperature exceeds a predetermined limit, such as about 100° F. In this blocked mode, a bleed hole through a downstream end of the rotary valve sleeve permits a small water bleed flow that is insufficient to produce the desired eyewash flushing streams, but is sufficient to permit water to flow through the valve sleeve and thereby promptly unblock the water flow to and through the eyewash ports when the water temperature falls to a temperature less than the predetermined limit.

Other features and advantages of the present invention will become more apparent from the following detailed description taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view showing the faucet mounted eyewash unit of the present invention in an eyewash mode;

FIG. 2 is an exploded perspective view of the faucet mounted eyewash unit of FIG. 1;

FIG. 3 is a perspective view corresponding generally with FIG. 1, but shown in vertical section to illustrate internal construction details thereof;

FIG. 4 is a front elevational view showing the eyewash unit mounted onto the discharge end of a faucet spout, and oriented in a normal faucet mode;

FIG. 5 is a vertical sectional view similar to FIG. 3, but showing the eyewash unit in the normal faucet mode;

FIG. 6 is a front elevational view similar to FIG. 4, but depicting rotary displacement of a portion of the eyewash unit between the normal faucet mode and the eyewash mode;

FIG. 7 is a front elevational view similar to FIGS. 4 and 6, but showing the eyewash unit in the eyewash mode;

FIG. 8 is a vertical sectional view similar to FIG. 2, showing the eyewash unit in the eyewash mode;

FIG. 9 is a transverse vertical sectional view taken generally on the line 9-9 of FIG. 8;

FIG. 10 is an enlarged portion of the transverse vertical sectional view of FIG. 9, generally corresponding with the encircled region 10; and

FIG. 11 is a transverse vertical sectional view taken generally on the line 11-11 of FIG. 8.

### DETAILED DESCRIPTION OF THE PREFERRED EMBODIMENTS

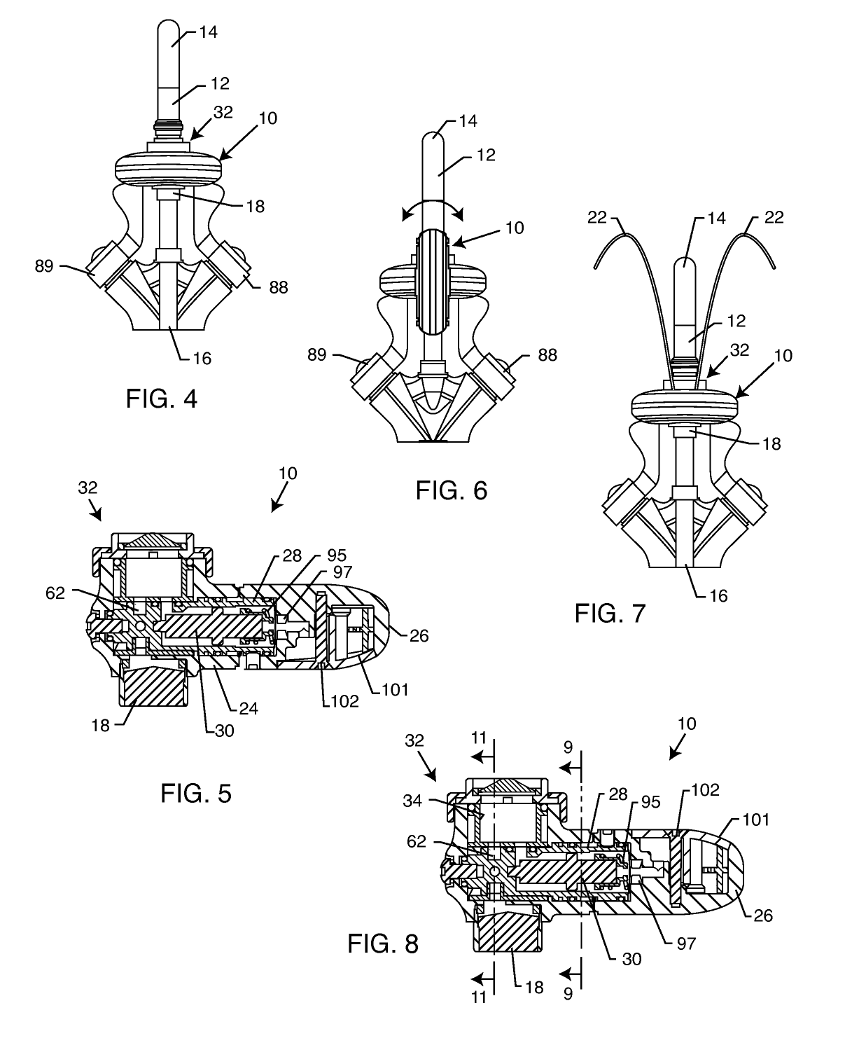

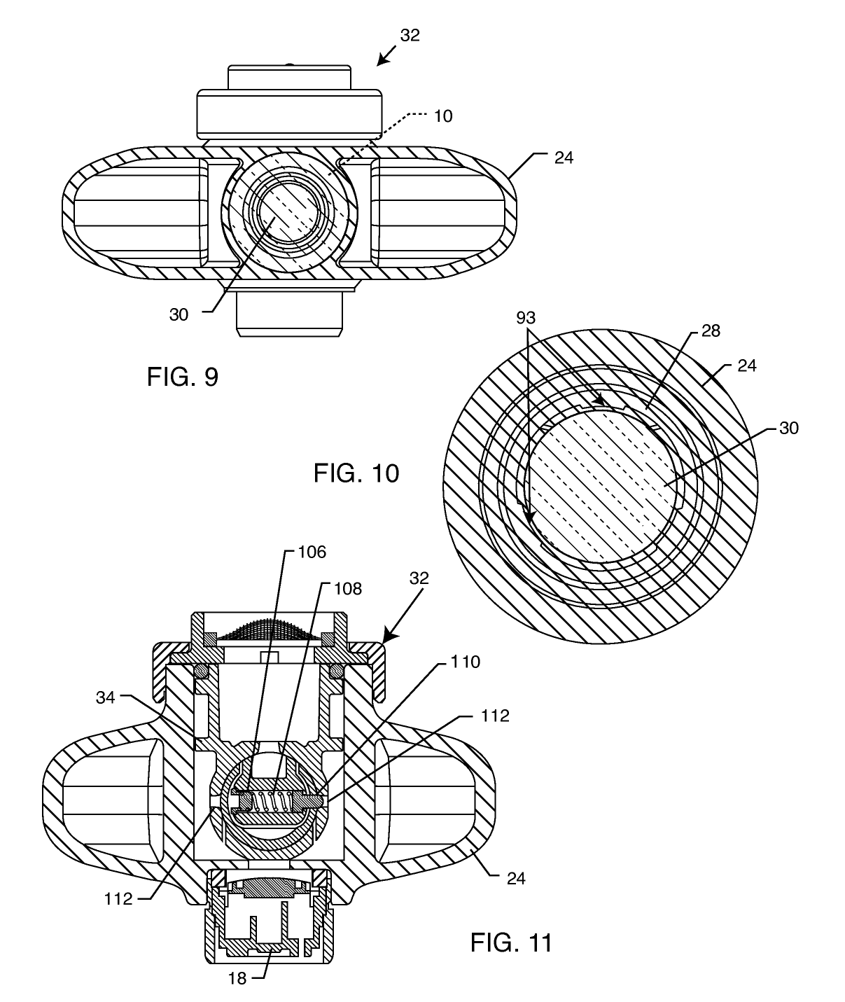

As shown in the exemplary drawings, a faucet mounted eyewash unit referred to generally in the accompanying drawings by the reference numeral 10 is adapted for mounting onto the discharge end 12 of a conventional faucet spout 14. The eyewash unit 10 is movable quickly and easily, and in a single motion, between a normal faucet mode orientation shown in FIG. 4 for normal downward discharge of a faucet water stream 16 through a conventional aerator 18 or the like, and an eyewash mode orientation shown in FIG. 7 wherein a pair of eyewash ports 20 are coupled with the faucet flow for upward discharge of a pair of relatively gentle eyewash flush or irrigation flow streams 22. In the most preferred form of the invention as shown in the accompanying drawings, the eyewash flush flow streams diverge generally in opposite directions to flush contaminants from a person's eyes in an inside-out direction, substantially without flushing such contaminants into and/or through the person's tear ducts and/or the sinus cavities.

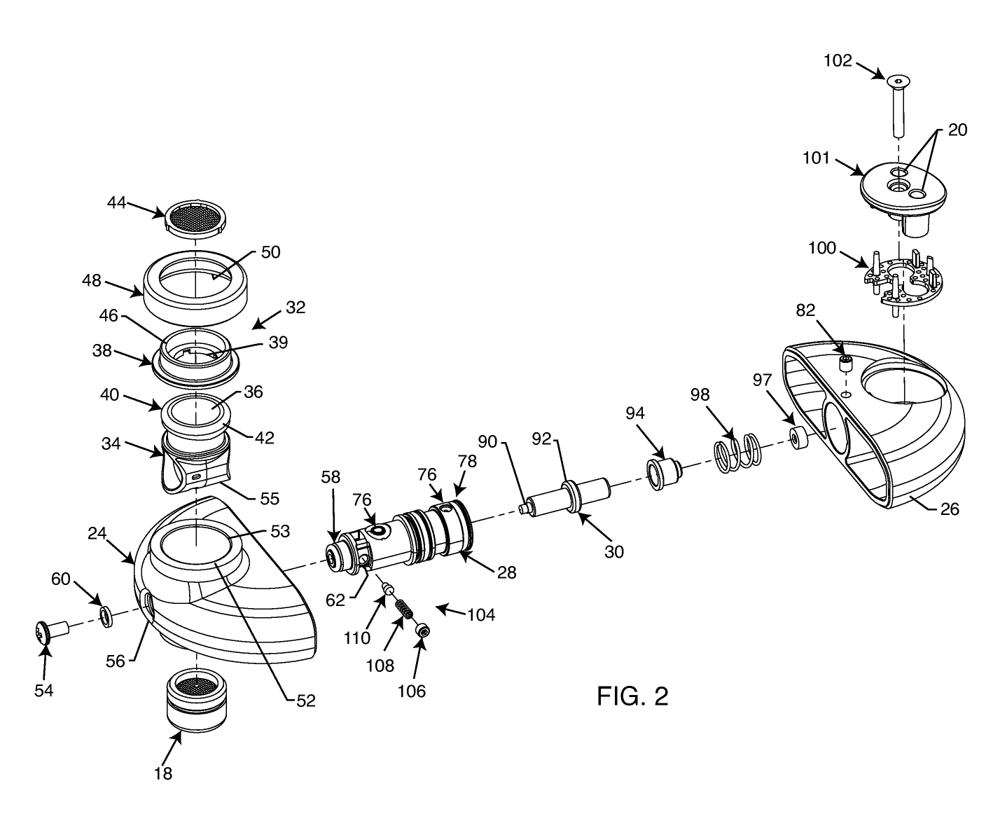

In general terms, the faucet mounted eyewash unit 10 of the present invention comprises a unit housing defined by a first or fixed portion 24 adapted for secure mounting onto the discharge end 12 of the faucet spout 14, and a second or movable portion 26 which is quickly and easily rotated (as shown best in FIG. 6) in either direction between the faucet mode position (FIG. 4) and the eyewash mode position (FIG. 7). In the normal faucet mode position (FIG. 4), the eyewash ports 20 are oriented on the second portion 26 of the unit housing to open and drain downwardly, thereby preventing unwanted water accumulation therein and related generation of mold and the like. By contrast, however, in the eyewash mode position (FIG. 7), the eyewash ports 20 are rotated to open in an upward direction to produce the upwardly directed eyewash streams 22. In this regard, upon rotation of the second portion 26 of the unit housing to the eyewash mode position, relative to the first portion of the unit housing, an internally mounted rotary valve sleeve 28 (FIG. 2) is rotated with the second portion 26 for coupling a portion of the faucet water flow to the eyewash ports 22. Importantly, this rotary valve 28 is associated with a thermostat cartridge 30 which limits the temperature of water coupled to the eyewash ports 22.

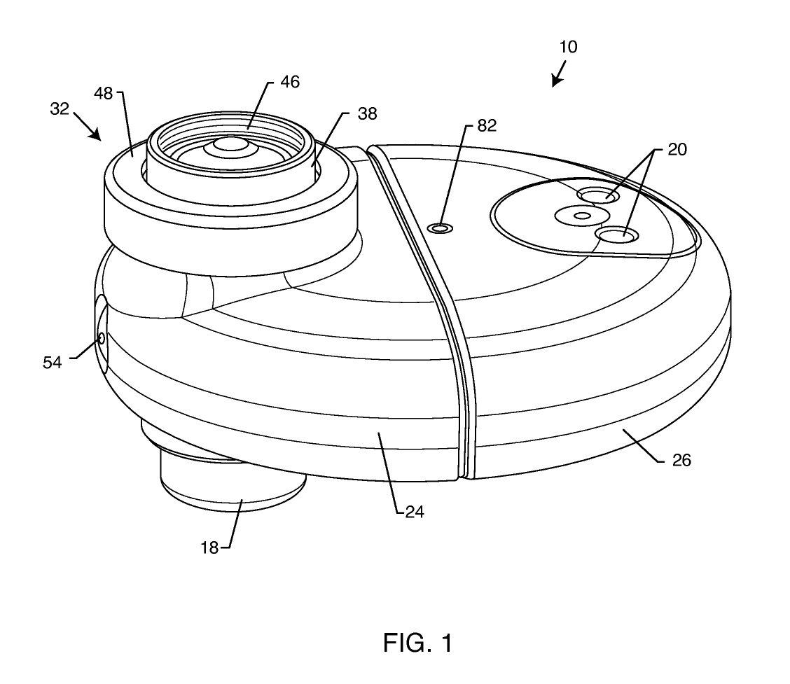

FIGS. 1-3 and 7-8 illustrate the eyewash unit 10 in the eyewash mode orientation with the pair of eyewash ports 20 opening in an upward direction from the second, rotatable portion 26 of the unit housing. FIG. 2 shows the eyewash unit 10 in exploded form to include the various components thereof.

As shown in FIG. 2, the first or fixed portion 24 of the eyewash unit 10 includes locking means 32 for sealed and locked mounting onto the discharge end 12 of the faucet spout 14. In this regard, a valve plug 34 holds an annular seal member 40 such as an O-ring or the like which is carried at the upper end of an upwardly open and generally cylindrical collar 36 and assists in sealing against a faucet interface ring 38 on the collar 36, as by means of an internal flange 39 on the interface ring 38 engaging the seal member 40 to retain said member 40 against a short outwardly projecting flange 42 at the upper end of the collar 36. A filter screen washer 44 may be entrapped axially between the internal ring flange 39 and the discharge end 12 of the faucet spout 14.

The faucet interface ring 38 is internally threaded, as indicated by reference numeral 46, for appropriate thread-on engagement with the discharge end 12 of the faucet spout 14. A mating locknut 48 is mounted in turn over the interface ring 38 and includes internal threads 50 for thread-on engagement with external threads 52 on a short upstanding boss 53 on the first or fixed portion 24 of the unit housing to sealingly lock the eyewash unit 10 onto the discharge end 12 of the faucet spout 14 and holds the assemblies in place. In this regard, the internal threads 46 on the faucet interface ring 38 are selected for appropriate and suitable engagement with mating threads (not shown) on the faucet spout discharge end 12. Persons skilled in the art will recognize and appreciate that alternative interface rings 38 having different appropriate-sized threads 46 thereon may be used according to the thread type and size at the spout discharge end 12. Persons skilled in the art will also understand that the eyewash unit 10 can be mounted onto a faucet spout discharge end 12 in virtually any desired rotational orientation, with the exemplary drawings showing mounting of the eyewash unit 10 to extend forwardly from the faucet spout.

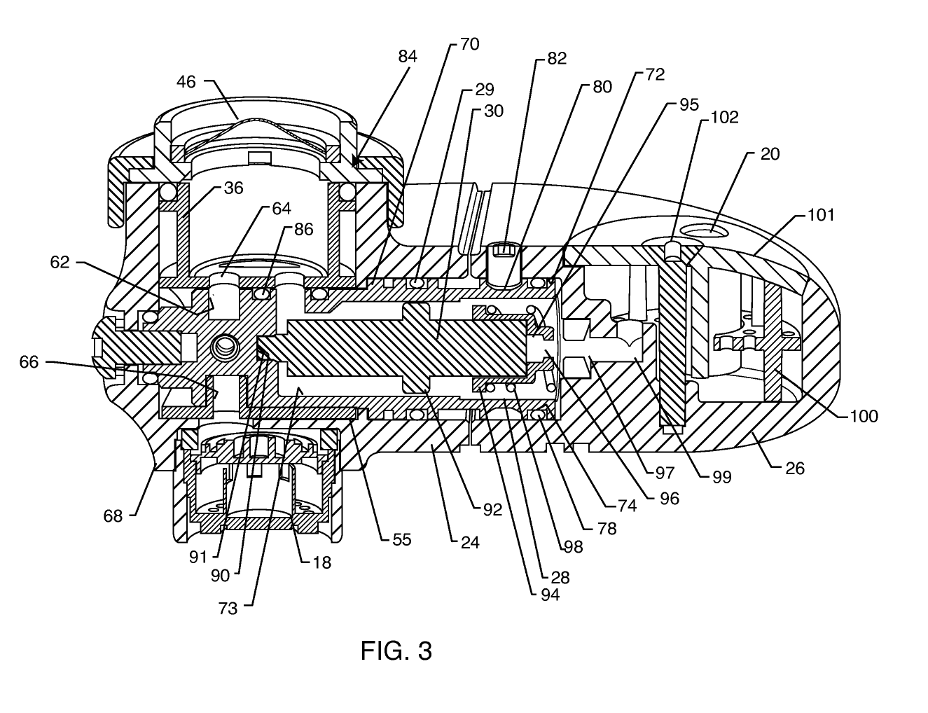

The rotary valve sleeve 28 is normally retained within the first or fixed portion 24 of the unit housing, and also within a lower segment 55 of the valve plug 34, as by means of a threaded screw 54 fitted through an open port 56 in the first portion 24 and threaded into a rear end of the rotary valve 28 at a threaded port 58. A washer 60, such as a Teflon washer or the like, is provided between the head of the screw 54 and the exterior of the first portion 26 to accommodate smooth valve sleeve rotation with respect thereto, as will be described herein in more detail. A circumferential channel 62 (shown best in FIG. 3) is formed in the rotary valve sleeve 28 to permit water downflow through the spout locking means 32 and further through a port 64 in the valve plug 34, through the channel 62 and downwardly through a discharge port 66 formed in the lower segment 55 of the valve plug 34. The aerator 18 is removably threaded into a shallow, internally threaded boss 68 formed in the underside of the first or fixed portion 24 of the unit housing for downflow of the faucet water stream 16 (FIG. 4) into an underlying sink (not shown) and/or drain (also not shown).

FIG. 5 shows the rotary valve sleeve 28 in the normal faucet mode orientation. In this position, the rotary valve sleeve 28 projects laterally from the channel 62 through a laterally open bore 70 formed in the fixed portion 24, and into an aligned laterally open bore 72 formed in the movable second portion 26 of the unit housing. Within this second portion 26 of the unit housing, the rotary valve sleeve 28 is coupled to the second portion 26 to accommodate rotatable displacement thereof between the faucet mode and eyewash mode positions, with the rotary valve sleeve 28 coupling a portion of the faucet water flow to the eyewash ports 20 when the second portion 26 is in the eyewash mode position.

More particularly, the rotary valve sleeve 28 comprises an elongated and generally tubular component having a forward end defined by multiple axially spaced circumferential grooves 74. One of these grooves 74 is positioned within the bore 70 of the first or fixed portion 24 of the unit housing, and carries an annular seal member 76 such as a resilient O-ring or the like for preventing leakage therebetween. A second one of these grooves 74 is disposed within the bore 72 of the movable second portion 26 of the unit housing and carries a second annular seal member 78 such as a resilient O-ring or the like for preventing leakage therebetween. A shallow recess 80 near this second seal member 78 receives the tip of a set screw 82 or the like fastened into and partially through the wall of the second portion 26 of the housing unit to retain the rotary valve sleeve 28 relative to the second portion 26.

In the normal faucet mode orientation of the rotary valve sleeve 28, water flow from the faucet (through the locking means 32) is free to flow further through the open channel 62 defined by the rotary valve sleeve 28 and downwardly through the aerator 18 for normal discharge (FIG. 4). However, when the second portion 26 of the housing unit is rotated as viewed in FIG. 6 to the eyewash mode position shown in FIG. 7, an inlet port 84 formed in the rotary valve sleeve 28 at a position axially adjacent to the channel 62 permits some of the water flow to enter a bore 73 formed in the interior of the rotary valve sleeve 28 for flow as will be described to the eyewash ports 20. A seal member 86 such as an O-ring seal or the like is provided for sealably engaging the lower segment 55 of the valve plug 34.

More specifically, the thermostat cartridge 30 is fitted into the rotary valve sleeve 28 and functions in operation to permit unobstructed water flow to the eyewash ports 20, when the water temperature is at or below a predetermined threshold, such as about 100° F. However, if the water temperature exceeds the predetermined threshold, the thermostat cartridge 30 functions to prevent or obstruct sufficient water flow to the eyewash ports 20 to preclude generation of the upwardly projected eyewash flush flow streams 22 shown in FIG. 7. Instead, the thermostat cartridge permits a smaller bleed flow to and through the eyewash ports 20 so that cooler water, when and if available (as by adjusting the cold and hot water faucets 88 and 89 shown in FIGS. 4 and 6-7) and their associated hot and cold water flows, is promptly supplied to the eyewash ports 20 to re-generate the desired eyewash flush flow streams 22.

In a preferred form, the thermostat cartridge 30 comprises a so-called wax motor element available from Kerox Ltd. of Budapest, Hungary, under the exemplary model no. WM-5. Such thermostat cartridge 30 generally comprises an external copper casing defining an axial end 90 seated within a socket 91 formed in the rotary valve sleeve 28 adjacent the channel 62, and a radially enlarged flange 92 carried coaxially within the sleeve bore 73. The sleeve bore 73 is lined with preferably at least 3 inwardly radiating ribs 93 (FIG. 10) for providing normal and sufficient radial clearance to permit axial water flow from the inlet port 84 around the thermostat cartridge 30 to a discharge end received within an open-ended thermostat cap 94 (shown best in FIGS. 2-3). This cap 94 has an end wall 95 with a small bleed hole 96 formed therein at an axial position adjacent a flow restrictor washer 97 seated in the second housing unit portion 26, with a small compression spring 98 being axially interposed between the end wall 95 of the cap 94 and the flow restrictor 97. A flow path 99 leads downstream from this flow restrictor 97 to and through a diffuser plate 100, and further to a discharge port member 101 defining the pair of eyewash ports 20. A screw 102 or the like is provided for quick and easy installation of the discharge port member 101 onto the second housing unit portion 26.

The interior of the copper clad thermostat cartridge 30 (not shown in the accompanying drawings) is filled with a mixture of copper particles and wax, with the specific mixture ratio selecting the specific predetermined maximum temperature of thermostat response. In this regard, the thermostat cartridge expands axially in response to increasing temperature of the water flowing thereover, until a downstream end of the thermostat cartridge 30 contained within the cap 94 compresses the spring 98 sufficiently for cap contact with an upstream side or upstream face of the flow restrictor 97. When this cap-flow restrictor contact occurs, further water flow through the flow restrictor 97 to the eyewash ports 20 is limited to the size of the bleed hole 96 formed in the cap end wall 95. Such water flow is, as previously described, insufficient to produce the desired upwardly projecting flush flow streams 22 (FIG. 7), but is sufficient for quick reaction to water temperature adjustment as by means of adjusting the cold and hot water faucet valves 88, 89 (FIGS. 4 and 6-7) to lower the water temperature.

During eyewash flush flow operation, the thermostat cap 94 is axially retracted from the flow restrictor 97, to permit a larger water flow around the exterior of the cap 94 due to the inwardly radiating spacer ribs 93 formed within the bore 73 of the valve sleeve 28. This larger water flow is limited only by the aperture size of the flow restrictor washer 97 but is sufficient to produce the upwardly projected eyewash flush flow streams 22 (FIG. 7). The balance of the faucet water flow is free to pass through the channel 62 and aerator 18 for normal faucet usage. In one preferred form, the flow restrictor 97 accommodates a water flow of about 0.9 gallons per minute (gpm), whereas the aerator 18 accommodates a water flow of about 0.5 gpm. Thus, in the eyewash mode orientation, with a potential faucet spout discharge on the order of about 1.5 gpm or greater, faucet use may continue uninterrupted despite generation of the eyewash flush flow streams 22 in the eyewash mode orientation.

The second or movable portion 26 of the unit housing is quickly and easily rotatable as viewed in FIG. 6 between the normal faucet mode position (FIG. 4) and the eyewash mode position (FIG. 7). This movement desirably proceeds in a single motion, and may occur while there is downward water flow through the faucet aerator 18. Importantly, as shown in FIG. 7, such downward faucet aerator flow is not redirected or interrupted. A detent assembly 104 (FIGS. 2 and 11) including a set screw 106 and a spring 108 for normally urging a detent pin 110 for seated reception into either one of a pair of recessed detent seats 112 formed in the valve plug 34 is provided for easily detectably tactile feedback to insure quick and easy housing unit rotation between the normal faucet mode (FIG. 4) and the emergency eyewash mode (FIG. 7).

A variety of modifications and improvements in and to the faucet mounted eyewash unit of the present invention will be apparent to those persons skilled in the art. For example, persons skilled in the art will recognize and appreciate that the thermostat cartridge 30 can be designed for axial expansion to contact the flow restrictor 97 at virtually any selected predetermined water temperature. Accordingly, no limitation on the invention is intended by way of the foregoing description and accompanying drawings, except as set forth in the appended claims.

Page 13 of 19

What is claimed is:

1. A faucet mounted eyewash unit, comprising:
a first portion adapted for attachment to a faucet spout and including means for delivering a normal faucet water flow therefrom; and
a second portion movably carried by said first portion and including a pair of eyewash flow ports, said second portion being movable between a normal faucet mode position with said first portion delivering a normal faucet water flow therefrom, and an eyewash mode position wherein at least a portion of the normal faucet water flow is diverted to said pair of eyewash flow ports to produce a pair of eyewash flush flows to flush contaminants from a person's eyes.

2. The faucet mounted eyewash unit of claim 1 wherein said first portion is adapted for connection to a downstream lower end of a faucet spout, and said means for delivering said normal faucet water flow delivers said normal faucet water flow downwardly from said first portion and the faucet spout.

3. The faucet mounted eyewash unit of claim 2 wherein said second portion is rotatably carried by said first portion for movement between said normal faucet mode position with said eyewash ports opening and draining downwardly, and said eyewash mode position with said eyewash ports opening upwardly.

4. The faucet mounted eyewash unit of claim 3 wherein said eyewash ports are oriented to provide said pair of eyewash flush flows to project generally upwardly and to diverge generally in opposite directions from each other.

5. The faucet mounted eyewash unit of claim 1 further comprising a lock assembly for thread-on securement of said first portion to said faucet spout.

6. The faucet mounted eyewash unit of claim 1 further comprising an aerator carried by said first portion for passage of said normal faucet water flow therethrough.

7. The faucet mounted eyewash unit of claim 1 further comprising a rotatable valve sleeve carried between said first and second portions, said valve sleeve having a channel formed therein for passage of said normal faucet water flow therethrough when said second portion is in said normal faucet mode position, said valve sleeve further including means for preventing water flow to said eyewash ports when said second portion is in said normal faucet mode position.

8. The faucet mounted eyewash unit of claim 7 wherein said valve sleeve has an inlet port formed therein for permitting water flow to said eyewash ports when said second portion is in said eyewash mode position.

9. The faucet mounted eyewash unit of claim 8 further including a flow restrictor disposed between said inlet port and said eyewash ports for limiting eyewash port water flow when said second portion is in said eyewash mode position.

10. The faucet mounted eyewash unit of claim 9 wherein said flow restrictor limits water flow to said eyewash ports to about 0.9 gallons per minute, when said second portion is in said eyewash mode position.

11. The faucet mounted eyewash unit of claim 8 further including a thermostat disposed between said inlet port and said eyewash ports for preventing water flow to said eyewash ports at a temperature above a preselected limit, when said second portion is in said eyewash mode position.

12. The faucet mounted eyewash unit of claim 11 wherein said preselected limit is about 100° F.

13. The faucet mounted eyewash unit of claim 1 further including detent means for tactile indication of said normal faucet mode and said eyewash mode positions of said second portion.

14. A faucet mounted eyewash unit, comprising:
a first portion adapted for attachment to a downstream lower end of a faucet spout and including means for delivering a normal faucet water flow therefrom in a downward direction; and
a second portion rotatably carried by said first portion and including a pair of eyewash flow ports; said second portion being movable between a normal faucet mode position with said first portion delivering a normal faucet water flow therefrom and with said eyewash ports opening and draining generally in a downward direction, and an eyewash mode position wherein said pair of eyewash flow ports are oriented to open generally in an upward direction and at least a portion of the normal faucet water flow is diverted to said pair of eyewash flow ports to produce a pair of eyewash flush flows to flush contaminants from a person's eyes.

15. The faucet mounted eyewash unit of claim 14 wherein said eyewash ports are oriented to provide said pair of eyewash flush flows to project generally upwardly and to diverge generally in opposite directions from each other.

16. The faucet mounted eyewash unit of claim 15 further comprising a rotatable valve sleeve carried between said first and second portions, said valve sleeve having a channel formed therein for passage of said normal faucet water flow therethrough when said second portion is in said normal faucet mode position, said valve sleeve further including means for preventing water flow to said eyewash ports when said second portion is in said normal faucet mode position, said valve sleeve further having an inlet port formed therein for permitting water flow to said eyewash ports when said second portion is in said eyewash mode position.

17. The faucet mounted eyewash unit of claim 16 further including a flow restrictor disposed between said inlet port and said eyewash ports for limiting eyewash port water flow when said second portion is in said eyewash mode position.

18. The faucet mounted eyewash unit of claim 16 further including a thermostat disposed between said inlet port and said eyewash ports for preventing water flow to said eyewash ports at a temperature above a preselected limit, when said second portion is in said eyewash mode position.

19. The faucet mounted eyewash unit of claim 14 further including detent means for tactically indicating said normal faucet mode and said eyewash mode positions of said second portion.
